(19) United States
(12) Patent Application Publication
(10) Pub. No.: US 2026/0145623 A1
(43) Pub. Date: May 28, 2026

(54) WINDSHIELD SENSOR ENVIRONMENTAL SHIELD

(71) Applicant: Michelle Chalmers, Charlton, MA (US)

(72) Inventor: Michelle Chalmers, Charlton, MA (US)

(21) Appl. No.: 19/348,100

(22) Filed: Oct. 2, 2025

Related U.S. Application Data
(60) Provisional application No. 63/724,644, filed on Nov. 25, 2024.

(51) Int. Cl. B60R 11/04; B60R 11/00

(52) U.S. Cl. CPC B60R 11/04; B60R 2011/0026; B60R 2011/0063

(57) ABSTRACT

A shielding device for forward facing and/or windshield mounted/located sensors on an automobile protects sensors in close proximity to the windshield from temperature extremes associated with sunlight and extreme cold or wind. Modern automobiles tend to locate forward-focused collision avoidance sensors (sensors) around the perimeter of the windshield, typically at a central, uppermost portion. The windshield is subject to a substantial solar load, often emphasized by the angle of the windshield in direct sunlight. A reflective, insulating substrate disposed over the windshield mitigates extreme heat that can damage sensors in thermal communication with the windshield surface. The substate is affixed via the door seam, magnetic attachment, or engagement with the side mirrors or wipers.

### RELATED APPLICATIONS

This patent application claims the benefit under 35 U.S.C. § 119(e) of U.S. Provisional Patent App. No. 63/724,644, filed Nov. 25, 2024, entitled “WINDSHIELD SENSOR ENVIRONMENTAL SHIELD,” incorporated herein by reference in entirety.

### BACKGROUND

Modern automobiles are often equipped with an abundance of sensors for mechanical control, diagnostic feedback and driver safety. Increasing complexity of modern vehicles imposes additional burdens on service personnel for diagnosing and repairing problems and malfunctions, and also may require advanced equipment and tools for access to the electronic systems which often utilize and interconnect the various sensors. These so-called automotive ADAS (Advanced Driver-Assistance Systems) sensors are specialized vehicle devices, such as cameras, LiDAR (Light Detection And Ranging), ultrasonic, and inertial measurement units (IMUs), that detect and interpret the vehicle's performance and environment to support driving and safety functions

### SUMMARY

A shielding device for forward facing and/or windshield mounted or harnessed sensors on an automobile protects sensors in close proximity to the windshield from temperature extremes associated with sunlight and extreme cold or wind. Modern automobiles tend to locate forward-focused collision avoidance sensors (sensors) around the perimeter of the windshield, typically at a central upper portion, often near or just below the roof. The windshield is subject to a substantial solar load, often emphasized by the angle of the windshield in direct sunlight. A reflective, insulating substrate disposed over the windshield mitigates extreme heat that can damage sensors in thermal communication with the windshield surface. The substate is affixed via the door seam, magnetic attachment, or engagement with the side mirrors or wipers.

The sensors, generally mounted on, around or just behind the windshield, include any kind of optical, ranging, object detecting or motion detecting device, and encompass technologies directed to camera/imaging, LiDAR, IR (infrared), RADAR (Radio Detection And Ranging), ultrasound, temperature, impact/accelerometer and/or magnetic. While often collectively referred to as ADAS sensors, the disclosed device is directed to any electronics and/or sensory medium providing safety focused driver assistance, and mitigates environmental extremes, typically heat, solar and cold, that may affect the often delicate electronics and sensory hardware employed by such sensors.

Configurations herein are based, in part, on the observation that forward facing sensors, such as cameras and distance sensors, are often adhered to an inside windshield surface and/or disposed immediately adjacent to the windshield surface. Further, on a hot day, with windows closed, the solar energy absorbed into the automobile through the glass tends to rise, heating the glass and surrounding region near the edges, typically where the forward facing sensors tend to be located. These sensors tend to be not only temperature sensitive, but also expensive in both parts and labor to replace. Unfortunately, conventional approaches to sensor protection rely on ineffective blue tinted regions along an upper band of the windshield, or on interior panels for reducing solar transmission into the vehicle. Also, vehicle sensors and cameras often require untreated, un-tinted glass in the forward range, hence must be located below the tint band. The disclosed approach addresses any suitable sensor position, however is particularly beneficial for forward facing ADAS sensors located just below this tint or shaded band running along the roofline of the windshield. The solar load imposed on these windshield based sensors is typically not mitigated by interior shading which resides behind the windshield-mounted sensors.

Modern vehicles are incorporating an increasing number of safety related sensors for enhancing driver perception of environmental conditions. Most commonly directed to cameras and object detection, these sensors enhance driver awareness of other vehicles, humans and any other object which may pose a potential hazard to the driver, passenger or adjacent vehicles, pedestrians and/or cyclists, for example. Still further, a learned reliance on these ADAS sensors renders the driver at a disadvantaged or degraded state when the sensors suddenly malfunction. Some industry professionals note that repair and replacement of such sensors are increasingly expensive because of more complex designs and greater integration with the driving experience. The onus is transferred to the vehicle owner to properly maintain and safeguard sensors, particularly upon expiration of warranty coverage, as the repair industry stands to benefit from the labor and parts intensive procedures of remediating failed sensors.

Accordingly, configurations herein substantially overcome the above shortcomings of conventional approaches by providing an environmental shielding device for vehicle electronic systems, including a planar shielding substrate adapted for parallel orientation adjacent to a sensor surface such as a windshield, and a coupling to an automobile fixture for engaging and/or affixing the substrate with the windshield surface. A protective coating on an exterior facing side of the substrate is resistant to environmental elements, particularly sunlight. A series of baffles or channels serves to ventilate and direct heated air away from the windshield surface. A supplemental insulative panel is located in an upper central region to align with the windshield mounted sensors. In an example arrangement, the protective coating is reflective of sunlight and thermally insulating, for reflecting solar rays and for providing a thermal buffer against heat or extreme cold.

In further detail, an environmental shielding device for windshield mounted automotive sensing systems (ADAS) includes a planar shielding substrate adapted for parallel orientation adjacent to a sensor surface, and a coupling to an automobile fixture for engaging the substrate with the sensor surface. A series of venting portions is configured for directing airflow over the sensor surface, thereby promoting cooling of the sensor surface, an adjacent sensor and associated electronics.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context view of a general configuration engaged with a vehicle windshield in a usage environment;

FIG. 2A is a side schematic view of cooling airflow in the environment of FIG. 1;

FIG. 2B shows a perspective view of the configurations of FIGS. 1 and 2A;

FIG. 2C shows stowed (contracted) arrangement of the configurations of FIGS. 1 and 2A-2B,

FIGS. 3A-3C show an alternate configuration and exploded view of layered fabric baffles in the configuration of FIGS. 1 and 2A-2C;

FIGS. 4A-4D show a further configuration with a rounded venting region around the sensor area;

FIGS. 5A-5D show articulated and angled baffles for directing heated air away from the sensor area;

FIGS. 6A-6E show cross sections of baffles for enhancing cooling airflow in the configurations of FIGS. 1-5D; and

FIG. 7 shows staggered alignment of fenestrations in the vented region of FIGS. 1-5D.

### DETAILED DESCRIPTION

Configurations herein depict an example of a windshield heat and solar shielding device for insulating and protecting automotive forward facing sensors, typically windshield mounted cameras and distance sensors, from extreme heat that tends to concentrate heat from sunlight and ambient temperatures along an upper region of the vehicle windshield. The device takes the form of a layered substrate adapted for affixation to the windshield surface.

The various vehicle manufacturers and models employ different sensor placement and have different types of sensors in varied locations. There is not an industry established or standard placement for collision avoidance or other sensors deployed on modern vehicles. In particular configurations, a vehicle specific sensor layout may be obtained from a vehicle database. The windshield mounted substrate establishes different layers or structures based on the vehicle specific configurations.

As sensors are often mounted on an upper central portion of the windshield, and are particularly common at the center near the rear-view mirror to avoid visual obstruction to the driver's line of sight, the upper central windshield region is of particular concern. Accordingly, the substrate is sized for covering at least an upper central portion of a vehicle windshield.

A common manufacturing practice includes a molded bracket shaped for receiving the sensor or camera, attached or adhered to the inside windshield surface. The sensor, typically an enclosed electronic component with a pin or plug based electrical connector, engages in a “snap-fit,” screwed and/or slot manner to the bracket. The bracket typically orients the sensor centrally, adjacent or aligned with the rear view mirror, and just below an upper band of tint or coating on the windshield. Any suitable sensor placement location, however, may benefit from the cooling and protection from environmental conditions described herein. The disclosed approach may conform to future evolutions of sensor placement as vehicle designs evolve.

Secure positioning of the disclosed device to the windshield may be provided by any suitable means, such as by a pair of opposed tethers defining the coupling to the windshield. The tethers are adapted for frictional or compressive engagement between a hinged and fixed surface, such as the car doors. By wrapping the tethers around the roof pillar and closing the door, a pinch fit secures the tethers between the door and pillar. An elastic linkage may connect the opposed tethers on the inside, across the dashboard, for easy one-handed securement.

Other coupling arrangements may include an articulating extension of the substrate, such as a foldable flap, where the extension is adapted to fold between a windshield frame and a hinged door. Other couplings may include a magnetic attachment to a ferrous surface around the windshield, as the glass surface will be surrounded by the roof, roof pillars and hood at the perimeter. While a hood or windshield wiper based mount might interfere with flush windshield communication, the upper portion where the sensors are likely disposed could still be covered.

In general, the substrate has a shape adapted to cover a windshield on the automobile and the protective coating is adhered to the substrate based at least on the sensor locations on the automobile. Various regions of the substrate may receive the reflective and/or insulating treatment. The entire substrate may be of a homogenous and/or layered construction affording the reflective and thermal protection around the entire windshield surface. Accordingly, selective reflective and/or thermal regions may be aligned with known sensor locations on the particular vehicle.

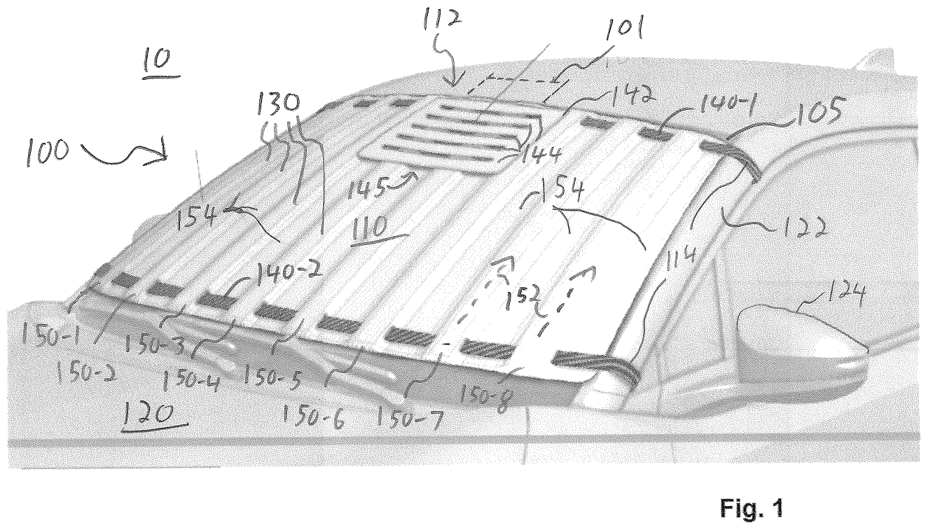

FIG. 1 is a context view of a general configuration engaged with a vehicle windshield 105 in a usage environment 10. Referring to FIG. 1, an environmental shielding device 100 for protection of windshield mounted automotive sensing systems 101 includes a planar shielding substrate 110 (substrate) adapted for parallel orientation adjacent to a sensor surface 112, and a coupling 114 to the vehicle 120 so protected. The coupling 114 is typically to an automobile fixture such as a windshield pillar 122 or side view mirror 124 for engaging the substrate 110 with the sensor surface 112. One or more venting portions 130 are configured for directing airflow over the windshield 105 and in particular, the sensor surface 112, thereby promoting cooling of the sensor surface 112 and sensing system 101 including the adjacent sensor and associated electronics.

It should be noted that in relevant context, a forward-facing camera is both a camera and a sensor, and while the use of the term “camera” is often more precise and descriptive because it highlights the technology used to capture visual data, the disclosed approach protects various sensory mediums. While it functions as a sensor by detecting objects and gathering data, the term “camera” specifies the type of sensor, which is beneficial for defining its capabilities and limitations, such as its strength in object recognition and relative differences in determining range compared to other non-visual technologies.

In the example of FIG. 1, the venting portion 130 further comprises a plurality of baffles 150-1 . . . 150-8 (150 generally), each defining parallel channels 152 generally oriented for upwards convection along a surface of the vehicle windshield 105. The baffles 150 form from alternating folds or deformations in the substrate 110 that raise the substrate 110 above a surface of the windshield 105 to form the channel 152 or void for allowing airflow. Contact portions 154 between the baffles 150 lie flat against the windshield 105 and allow for tethers 140-1 . . . 140-2 (140 generally) to define the coupling 114 to the vehicle 120/windshield 105. A vented region 145 on the substrate 110 is located based on a sensor 101 position on the windshield 105 for focusing additional venting, shielding and/or insulation, such that the vented region 145 is defined by a layered vent material 142 for convection. In addition to the venting portion 130 across the entire windshield 105, therefore, the layered vent material 142 provides additional cooling capacity, such as via vent openings 144 running orthogonal to the parallel channels 152. The substrate 110 is formed from a thermally insulative material for heat resistance complementary to the convective airflow through the channels 152.

Any suitable combination of venting portions 130 across the windshield complemented by vented regions 145 of additional insulation or cooling may be provided, typically based on the locations of the sensors 101. Most commonly, the ADAS sensors 101 are located behind the upper central windshield 105, behind or adjacent to the rearview mirror of the vehicle. This location, however, is vehicle manufacturer dependent, and the vented regions may be formed to align with the sensor 101 position. Some manufacturers locate sensors 101 across the entire upper edge of the windshield 105, and others along the lower edge or corners.

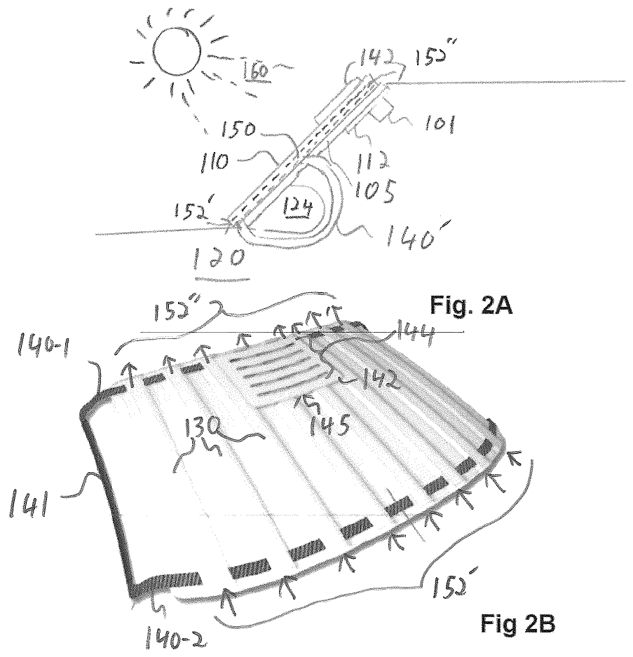

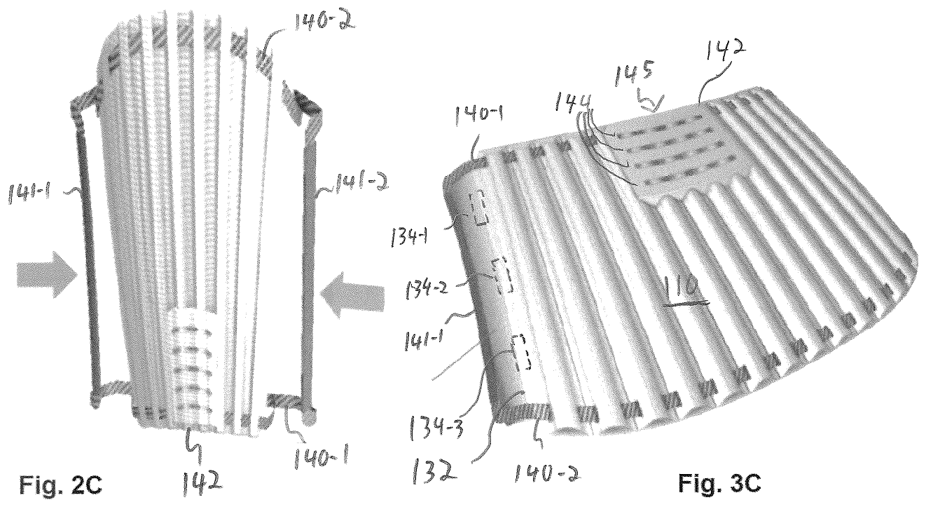

FIGS. 2A and 2B show a side schematic view and a perspective view (FIG. 2B) of cooling airflow in the environment of FIG. 1. Referring to FIGS. 1 and 2A-2B, the baffles 150 define the channels 152 that form an angled, generally upward convection path along the windshield 105. The sensor(s) 101 is typically located on or just behind the sensor surface 112 of the windshield 105. The vented region 145, in addition to receiving the cooling convective flow through the channels 150, is further shielded by the vent material 142 over the vented region 145 for imparting additional heat protection to the sensor surface 112, which tends to otherwise receive both direct sunlight 160 and is located in the hottest area of the vehicle 120 interior near the roof.

Sunlight 160 and ambient conditions generate heat for forming the convective flow through the channels from an input 152′ to an outflow 152′ at the uppermost edge of the substrate 110. The venting portions 130 may take a variety of forms, discussed further below, with the general effect of forming the cooling channels 152 for convective cooling. A pair of opposed tethers 140-1 . . . 140-2 (140 generally) define the coupling 114, such that the tethers 140 attach to the substrate 110 and are adapted for frictional or compressive engagement between a hinged surface, such as the car door, and fixed surface such as the pillar 122. Tethers 140 may join with a rigid or semi-rigid handle 141 joining the opposed tethers for allowing the tethers 140 to be pulled across the windshield 105 for tensioning the tethers to secure the substrate 110 to the windshield 105. Tethers 140 may be wrapped around the pillars 122 to be frictionally secured or “pinched” between a closed car door and the pillar 122. The tethers 140 may also form a loop 140′ from the opposed tethers, such that the loop is configured for a tensioned engagement with the vehicle side mirror 124. It should be apparent that the substrate 110 has a length and width based on the approximate size of the windshield 105, and may be varied to suit different manufacturer's windshield dimensions. Some configurations may pursue a more compact form factor of the substrate, focusing on the upper and/or central portion near the vented region 145.

FIG. 2C shows stowed (contracted) arrangement of the configurations of FIGS. 1 and 2A, in contrast to the deployed (expanded) view of FIG. 2B. Referring to FIGS. 1-2C, folds in the substrate 110 that define the baffles 150 and channels 152 perform double duty for contracting the substrate 110′ for stowage along the same folds. Handles 141-1 . . . 141-2 (141 generally), combined with tethers 140-1 . . . 140-2 formed from elastic straps provide a tendency to contract the substrate when not in use. Handles 141 and straps 140 may also be used to wrap around the substrate into a compact storage form, such as with hook-and-loop fasteners or clasps, for example.

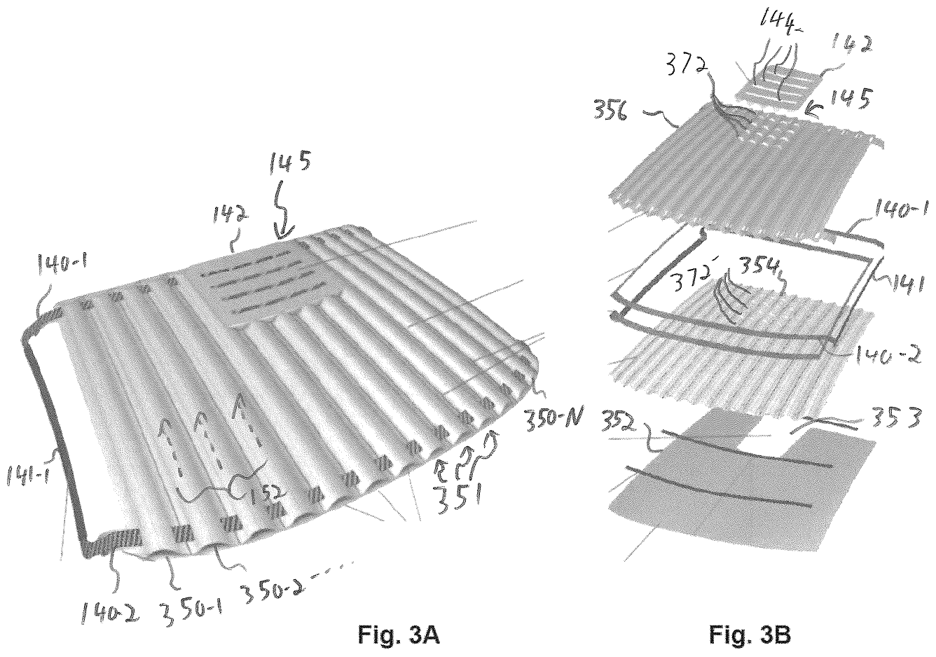

FIGS. 3A-3C show an alternate configuration and exploded view of layered fabric baffles 350-1 . . . 350-N (350 generally) in the configuration of FIGS. 1 and 2A. A parallel series of fabric baffles 350 impart a layered construct to the venting portions 130, while forming similar channels 152 upwards along the windshield 105 and across the vented region 145. The substrate 110 generally includes a thermally insulating material and a reflective surface on an exterior facing side of the substrate. The substrate 110 typically includes a plurality of layers including an externally facing reflective layer configured for solar reflection, a cooling layer for providing convectional cooling; and an internally facing reflective layer adapted for resisting radiated heat from a vehicle 120 interior.

In the arrangement of FIGS. 3A-3C, the fabric baffles 350 may be formed from pleats 351 in a middle fabric or insulative layer 354 stitched or attached to a lower foil or contact layer 352 for resting on the windshield 105. An excess of material in the middle layer 354 over the contact layer 352 causes the pleat 351. A top reflective and/or UV blocking layer 356 also follows the pleats 351. A void 353 around the vented region 145 facilitates airflow across the sensor surface 112.

Around the sensor surface 112 adjacent the sensor(s) 101, the vented region 145 has vent openings 144. The vent openings 144 are transverse slots in fluid communication with at least one of the channels 350 for convective venting through a set of vent openings formed by fenestrations 372 in the substrate, such that the vent openings 144 are unaligned with the fenestrations 372 for blocking sunlight infiltration. The fenestrations 372′ form a complete open path through the multiple layers to the channels 350.

Referring to FIG. 3C, the coupling 114 may further define an articulating extension of the substrate 110, such that the extension 132 is adapted to fold around the pillar 122 between a windshield frame and a hinged door. The extension may be defined by a pair of flaps 132, where the flaps 132 extend from opposed sides of the substrate 110 and are configured for a deformable fold around an edge of the windshield 105 for a compressive engagement with a vehicle door. Alternatively, the coupling 114 may further include a magnetic attachment to a ferrous surface around the windshield, such as magnetic elements 134-1 . . . 134-3 (134 generally) embedded in the flaps 132. A combination of the handles 141/tethers 140, flaps 132 and magnetic elements 134 may also be employed.

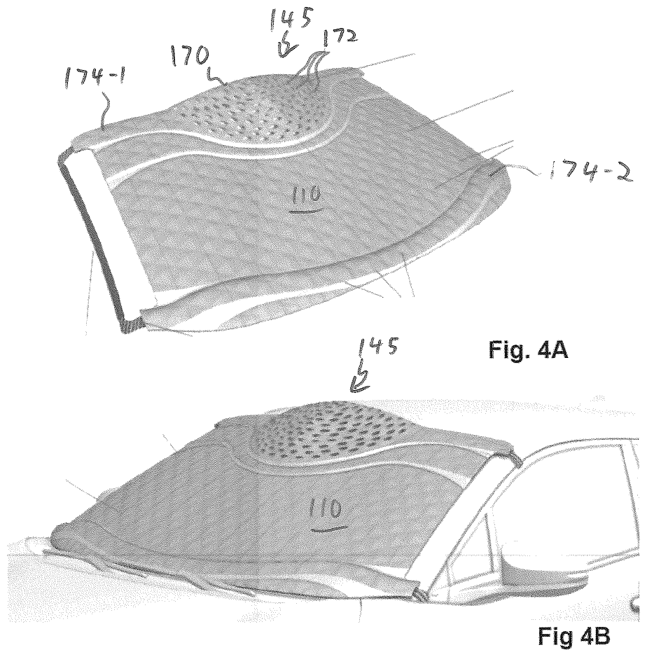

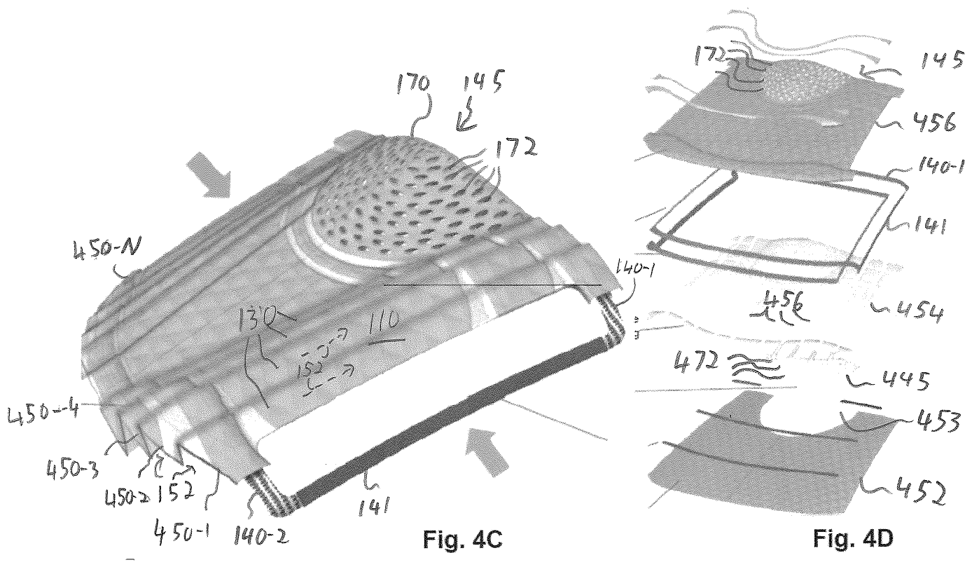

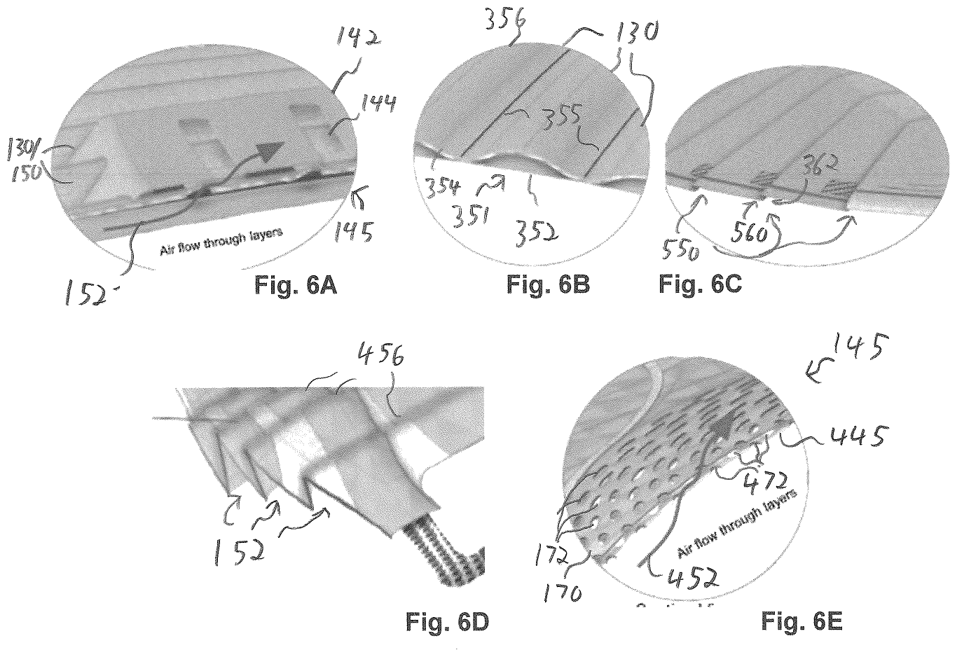

FIGS. 4A-4D show a further configuration with a rounded vented region 145 around the sensor area. The arrangement of the venting portions 130 along the substrate 110 and the positioning and venting features of the focused vented region 145 may be varied to suit the convection airflow and positioning of the various ADAS sensors located in the windshield 105 region. Referring to FIG. 1 and FIGS. 4A-4D, an alternate configuration includes a vented region 145 with a fenestrated portion 445 of the substrate 110, such that the fenestrated portion provides openings in the substrate 110 for airflow. In the configuration of FIGS. 4A-4D, the vented region 145 includes a venting layer 170 aligned with the fenestrated portion 445. Therefore, both the substrate 110 and the venting layer 170 have fenestrations, or vent openings for passing a convection flow of air, where the venting layer orients the vent openings defining fenestrations 172 in a radial pattern. Vent openings defined by the fenestrations 172 in the venting layer 170 are offset from the vent openings formed as fenestrations 472 in the substrate 110, such that the offset is for blocking direct sunlight 160 while complementing airflow, shown further below in cross section views of FIGS. 6A-6E.

In the configuration of FIGS. 4A-4D, the venting portions 130 continue to run parallel, and the coupling 114 includes a pair of sleeves 174-1, 174-2 (174 generally) containing the tethers 140. Venting portions 130 are separated by alternating folds of a fabric bridge to form the channels 152 as the baffles 450-1 . . . 450-N fold onto and partially overlap with an adjacent baffle 450. The resulting channels 152 are defined by the thickness of the substrate 110 as adjacent baffles 450 partially overlap.

The substrate 110 may be layered to include a reflective backing 452 for resting on the windshield 105 surface, and a segmented foam or PCV (polyvinyl chloride) layer 454 (segmented layer) with gaps or thin cross sections to align with the folds. The fenestrated portion 445 has fenestrations 472 offset or staggered from the fenestrations 172 in the venting layer 170. The offset of the fenestrations 472, 172 allows cooling, convection airflow from the channels 152 while blocking direct sunlight 160. A top layer 456 is a flexible and reflective material such as polyester that accommodates the overlapping folds in the segmented layer 454. Tethers 140 may run through slots or loops in the segmented layer 454.

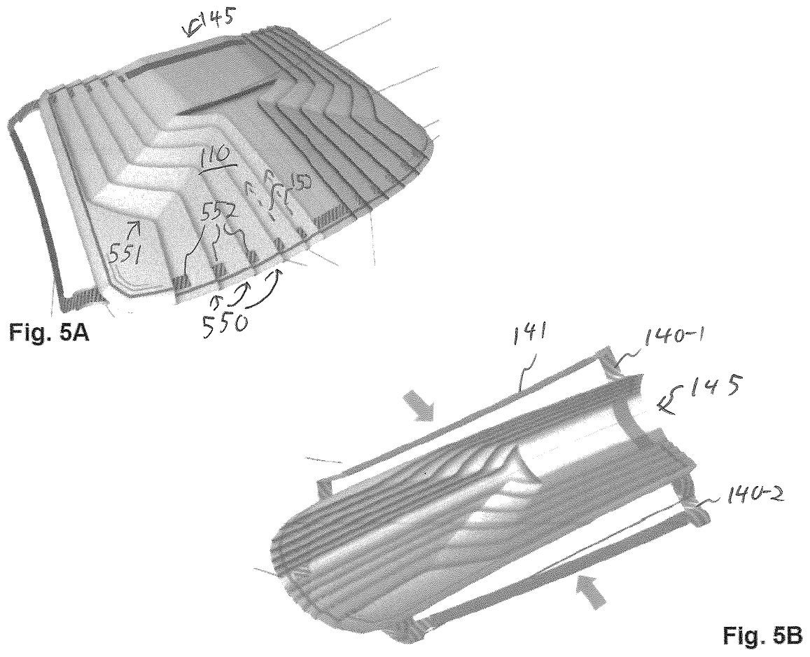

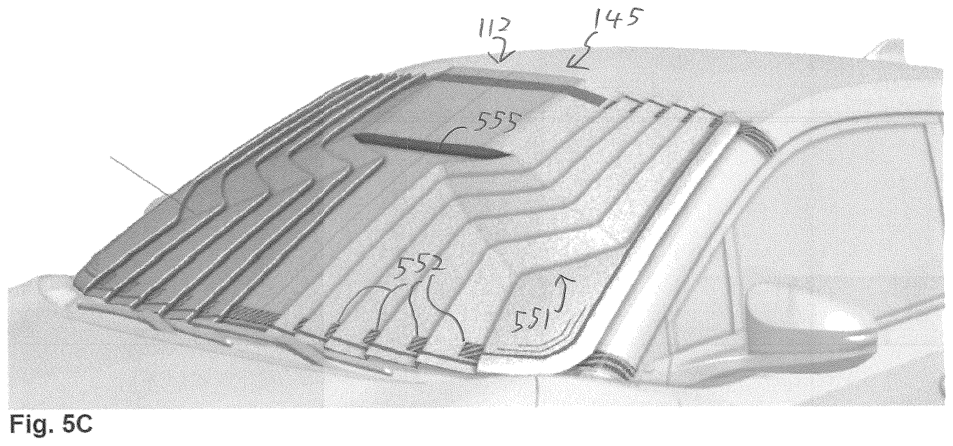

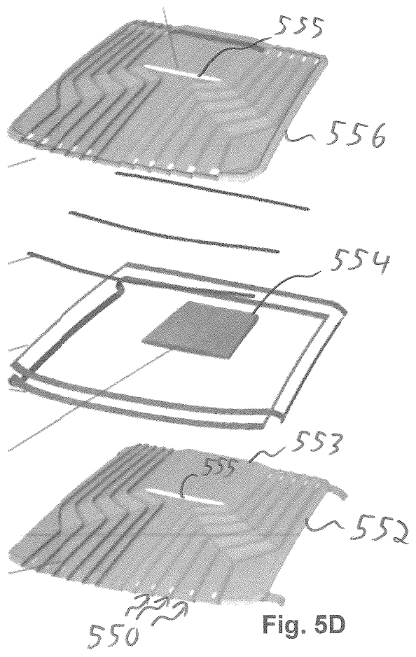

FIGS. 5A-5D show articulated and angled baffles for directing heated air away from the sensor area. FIGS. 5A-5D show an alternate configuration where the baffles 550 form an articulated angled path 551 around the vented region 145. Similar to the overlapping folds of FIGS. 4A-4D, adjacent baffles 550 form venting regions 130 based on overlapping folds of a fabric layer or tabs 552. The articulated angled path 551 directs heated, convection driven air from the windshield around the vented region 145, and provides a dedicated vent opening 555 for the sensor surface 112. A collapsed form (FIG. 5B) pulls the overlapping baffles 550 together flanking the vented region 145.

The bottom, or contact layer 552 against the windshield may be a reflective polyester or fabric, and allowing the vent opening 555 for the vented region 145. Only the vented region 145 is occupied by an insulating layer 554, such as open cell polyurethane foam, for insulating the sensor region 112. The reflective top layer 556 directs ambient sunlight away. By utilizing lightweight materials for the venting region 130 and baffles 550, and directing hot airflow around the sensor region 112 while providing separate a dedicated insulating layer 554 coupled with airflow from vent opening 555, the sensor region 112 experiences maximum cooling with minimum radiated or convection heat from the surrounding windshield 105.

Alternate configurations may modify the substrate size to be smaller, such as for covering only an upper central portion of a vehicle windshield, or covering the vented region 145 above the sensor surface 112 along an upper half and central one-third of the windshield 105.

FIGS. 6A-6E show cross sections of baffles for enhancing cooling airflow in the configurations of FIGS. 1-5D. FIG. 6A shows a detail of the vented region 145 in the configuration of FIGS. 2A-2C and 3A-3D. The channels 152 for convection are generally formed from concave or raised cross sections of the substrate 110. The layered vent material 142 rests above the venting regions 130/baffles 150 while vent openings 144 run transverse to the channels 152 across the vented region 145.

FIG. 6B shows a cross section of the pleats 351 of FIGS. 3A-3C form from the flat contact layer 352 and excess length in the middle layer 354 from intervals of seams 355.

FIG. 6C shows the overlapping baffle 550 structure defines a channel from the gap 562 from the overlap 560 with an adjacent baffle. Channels are formed from partially overlapping parallel portions of the substrate 110.

FIG. 6D shows the segmented middle layer 454 of FIGS. 4A-4D allowing a fold 456 to define the channels 152.

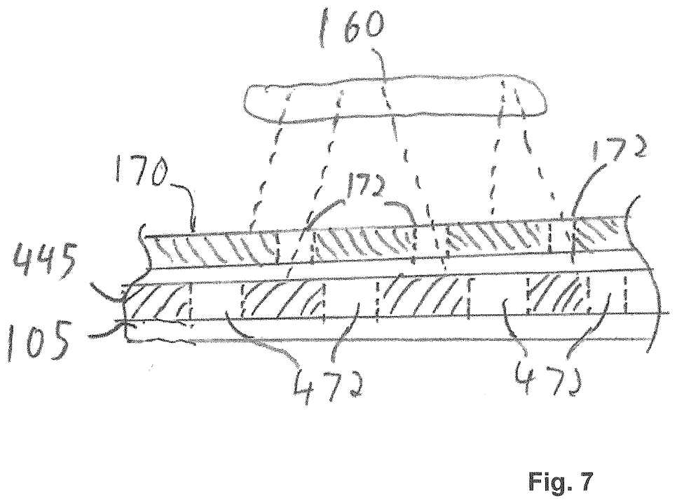

FIG. 6E shows a perspective view of the vented region 145 with a fenestration layer or portion 445 and the venting layer 170 with a series of fenestrations 172. FIG. 7 shows a side view with staggered alignment of fenestrations 172 in the vented region 145 of FIGS. 1-5D. The fenestrations 472 in the fenestrated portion 445 allow airflow from the channel 152. The venting layer 170 complements the airflow through fenestration 172, but the fenestrations 172 do not line up with fenestrations 472 below to block direct sunlight 160 from radiating the sensor surface 112

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. An environmental shielding device for windshield mounted automotive sensing systems, comprising:
a planar shielding substrate adapted for parallel orientation adjacent to a sensor surface of a vehicle windshield;
a coupling to an automobile fixture for engaging the substrate with the sensor surface; and
at least one venting portion configured for directing airflow over the sensor surface, thereby promoting cooling of the sensor surface, an adjacent sensor and associated electronics.

2. The device of claim 1 wherein the substrate is defined by a thermally insulating material, further comprising a reflective surface on an exterior facing side of the substrate.

3. The device of claim 1 wherein the substrate includes a plurality of layers, the plurality of layers including:
an externally facing reflective layer configured for solar reflection;
a cooling layer shaped for providing convectional cooling; and
an internally facing reflective layer adapted for resisting radiated heat from a vehicle interior.

4. The device of claim 1 wherein the venting portion further comprises a plurality of baffles defining parallel channels, the parallel channels oriented for upwards convection along a surface of a vehicle windshield.

5. The device of claim 4 further comprising a vented region on the substrate, the vented region located based on a sensor position on the windshield, the vented region defined by a layered vent material for convection.

6. The device of claim 5 wherein the layered vent material defines vent openings running orthogonal to the parallel channels.

7. The device of claim 5 wherein the vented region further comprises a fenestrated portion of the substrate, the fenestrated portion providing openings in the substrate for airflow; and
a venting layer aligned with the fenestrated portion, the venting layer having vent openings, the vent openings offset from the openings in the substrate, the offset for blocking direct sunlight and complementing airflow.

8. The device of claim 6 wherein the venting layer orients the vent openings in a radial pattern.

9. The device of claim 1 further comprising a pair of opposed tethers defining the coupling, the tethers attached to the substrate and adapted for frictional or compressive engagement between a hinged surface and fixed surface.

10. The device of claim 9 further comprising an elongated, rigid handle joining the opposed tethers, the rigid handles configured for tensioning the tethers to secure the substrate to the windshield.

11. The device of claim 9 further comprising a loop formed from the opposed tethers, the loop configured for a tensioned engagement with a vehicle side mirror.

12. The device of claim 1 wherein the coupling further comprises an articulating extension of the substrate, the extension adapted to fold between a windshield frame and a hinged door.

13. The device of claim 1 further comprising a pair of flaps, the flaps extending from opposed sides of the substrate and configured for a deformable fold around an edge of the windshield for a compressive engagement with a vehicle door.

14. The device of claim 1 wherein the automobile has a windshield and the coupling further comprises a magnetic attachment to a ferrous surface around the windshield.

15. The device of claim 1 wherein the baffles form an articulated angled path around the vented region.

16. The device of claim 1 wherein the channels are formed from partially overlapping parallel portions of the substrate.

17. The device of claim 1 wherein the channels are formed from concave cross sections of the substrate.

18. The device of claim 1 wherein the substrate is sized for covering at least an upper central portion of a vehicle windshield.

19. The device of claim 5 wherein the vented region is located along an upper half and central one-third of the substrate.

20. A windshield protective device for heat shielding for automotive ADAS (Advanced Driver-Assistance Systems) sensors, comprising:
a layered, planar substrate having a length and width for parallel orientation on a windshield surface adjacent the ADAS sensor, the layers including:
an externally facing reflective layer configured for solar reflection,
a middle cooling layer shaped for providing convectional cooling and formed from a thermally insulative material, and
an internally facing reflective layer adapted for resisting radiated heat from a vehicle interior;
the substrate defining a series of baffles oriented across the width for upward convection of heated air, the baffles forming a series of parallel channels;
a vented region located based on a position of the ADAS sensor and having a vent material layered onto the substrate;
the vented region having vent openings in fluid communication with at least one of the channels for convective venting through a set of fenestrations in the substrate, the vent openings unaligned with the fenestrations for blocking sunlight infiltration; and
opposed tethers attached along the length of the substrate, the opposed tethers having a deformability for contracting the substrate for storage, the opposed tethers attached to a coupling for engaging the vehicle.
